(19) United States
(12) Patent Application Publication
(10) Pub. No.: US 2025/0306502 A1
(43) Pub. Date: Oct. 2, 2025

(54) DEVELOPER CONTAINER

(71) Applicant: CANON KABUSHIKI KAISHA, Tokyo (JP)

(72) Inventors: Hiroki Shimizu, Shizuoka (JP); Naoki Matsumaru, Shizuoka (JP); Masato Tanabe, Shizuoka (JP)

(21) Appl. No.: 19/062,293

(22) Filed: Feb. 25, 2025

(30) Foreign Application Priority Data
Mar. 29, 2024 (JP) 2024-057905

(51) Int. Cl. G03G 15/08

(52) U.S. Cl. CPC G03G 15/0882; G03G 15/0889; G03G 2215/085

(57) ABSTRACT

A developer container is used, including developing roller, rotatable developer supplying roller, developing chamber provided with the developing roller and the supplying roller, developer housing configured to store the developer, and having opening that communicably connects the developer housing and the developing chamber, and stirring member provided inside the developer housing and configured to be rotatable in the same direction as the direction in which the supplying roller is rotated. A height of a rotation shaft of the stirring member is equal to or higher than a height of the rotational shaft of the supplying roller. The opening of the housing is provided with a sealing member. The sealing member is bonded on the upstream and downstream sides of the opening in the rotating direction of the stirring member, and is configured to peel off from the upstream side toward the downstream side.

### BACKGROUND OF THE INVENTION

### Field of the Invention

The present invention relates to a developer container.

### Description of the Related Art

Conventionally, there is an electrophotographic image forming apparatus that uses an electrophotographic image forming process and uses cartridges, such as a developing cartridge and a process cartridge, which are removable from the main unit of the image forming apparatus. As a developing apparatus included in such cartridges, there is an apparatus having a configuration including: a developing chamber that includes a developing roller and a developer supplying roller; and a developer housing where the developer is stored, and is provided with an opening that connects the developing chamber and the developer housing.

Such an opening is kept sealed with a sealing member so as to keep the developer housing of the developing apparatus sealed until the cartridge is put in use. By peeling off the sealing member from the opening at the timing when a user puts the cartridge in use, it becomes possible to supply the developer into the developing chamber from the developer housing.

As a configuration for peeling off the sealing member from the opening, a plurality of configurations have been disclosed. For example, Japanese Patent Application Laid-open No. 2020-091326 disclose using a rotating member provided to a developer housing so as to peel off the sealing member sealing an opening, and to open the developer housing. After the opening, the sealing member rotates integrally with the rotating member.

### SUMMARY OF THE INVENTION

It is preferable for developing apparatuses to be able to supply developer into the developing chamber more smoothy, and there is a demand for further improvements in the conventional structure.

With the foregoing in view, it is an object of the present invention to provide a configuration capable of supplying developer more smoothly into the developing chamber.

The present invention provides a developer container comprising:
a developing roller configured to supply developer to a photosensitive drum;
a supplying roller configured to be rotatable and to supply the developer to the developing roller;
a developing chamber provided with the developing roller and the supplying roller;
a developer housing configured to store the developer and having an opening that communicably connects the developer housing and the developing chamber; and
a stirring member provided inside the developer housing and configured to stir the developer, and moreover configured to be rotatable in a same direction as a direction in which the supplying roller rotates, wherein
a height of a rotation shaft of the stirring member is equal to or higher than a height of a rotation shaft of the supplying roller, in a gravitational direction,
the developer housing is enabled to be provided with a sealing member for sealing the opening, from a side of the developer housing,
in a state where the opening is sealed by the sealing member, the sealing member is bonded at an upstream bonded portion that is on an upstream side of the opening and also at a downstream bonded portion that is on a downstream side of the opening, in a rotating direction of the stirring member, and
the developer housing and the developing chamber come to communicate each other as a result of the sealing member peeling off, starting from the upstream bonded portion and then the downstream bonded portion.

According to the present invention, it is possible to provide a configuration capable of supplying developer more smoothly into the developing chamber.

Further features of the present invention will become apparent from the following description of exemplary embodiments with reference to the attached drawings.

### BRIEF DESCRIPTION OF THE DRAWINGS

FIG. 1 is a sectional view for explaining a configuration of a developing unit;

FIG. 2 is a schematic sectional view of an image forming apparatus;

FIG. 3 is a sectional view of a process cartridge;

FIG. 4 is a sectional view of the image forming apparatus;

FIG. 5 is a sectional view of the image forming apparatus;

FIG. 6 is a sectional view of the image forming apparatus;

FIG. 7 is an exploded perspective view of a drum unit;

FIG. 8 is an exploded perspective view of the developing unit;

FIG. 9 is an assembly perspective view of the process cartridge;

FIG. 10 is a perspective view of the process cartridge;

FIG. 11A is a sectional view for explaining a configuration for opening a sealing member;

FIG. 11B is a subsequent sectional view for explaining the configuration for opening a sealing member;

FIG. 11C is a subsequent sectional view for explaining the configuration for opening a sealing member;

FIG. 12A is a partial sectional view for explaining a behavior of developer around a developer supplying roller;

FIG. 12B is a partial sectional view for explaining a subsequent behavior of the developer around the developer supplying roller; and

FIG. 13 is a sectional view for explaining a configuration for supplying the developer into a void formed inside a developing chamber.

### DESCRIPTION OF THE EMBODIMENTS

A preferred embodiment of the present will now be illustratively explained in detail with reference to drawings. The sizes, materials, shapes, and relative positioning of the elements described below in the embodiment are intended to be changed, as appropriate, depending on the configuration of an apparatus to which the present invention is applied, or on various conditions. The embodiment is thus not intended to limit the scope of the present invention thereto, except specifically described otherwise.

### Embodiment

The embodiment of the present invention will now be explained with reference to drawings. In the embodiment, an image forming apparatus with four removable process cartridges will be described as an example of the image forming apparatus. However, the number of process cartridges to be mounted on the image forming apparatus is not limited thereto, and is set to an appropriate number, as necessary.

In the embodiment described below, a laser beam printer will be used as an example of the image forming apparatus.

### General Configuration of Image Forming Apparatus

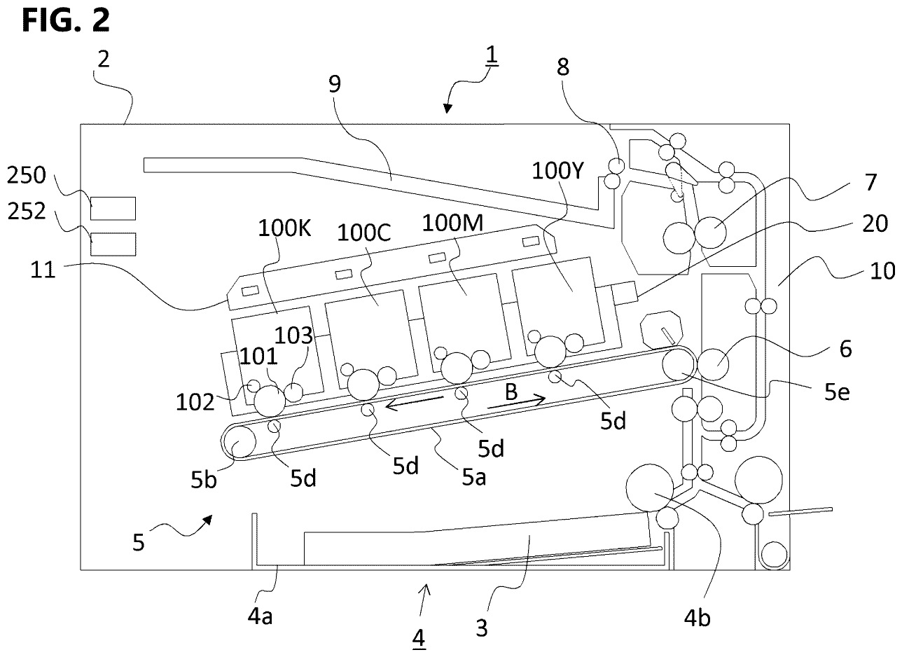

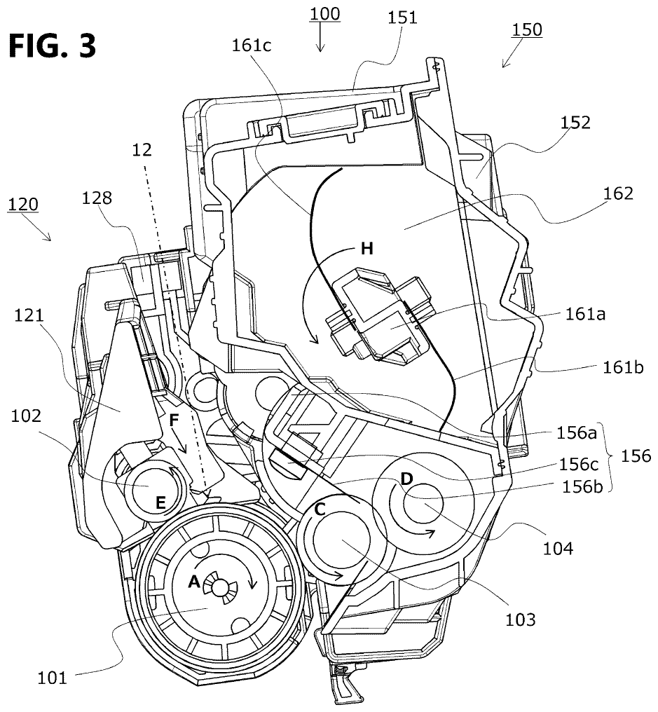

The overall configuration of an electrophotographic image forming apparatus according to this embodiment (hereinafter, referred to as an image forming apparatus 1) will now be explained with reference to FIG. 2. FIG. 2 is a schematic sectional view of the image forming apparatus 1. FIG. 3 is a sectional view of a process cartridge 100.

This image forming apparatus 1 is a four-full color laser beam printer that uses an electrophotographic process to form a color image on a recording medium 3. The image forming apparatus 1 is also configured to use a process cartridge that is mounted removably on an image forming apparatus main unit 2, and is configured to form a color image on the recording medium 3 using the process cartridge 100.

In the description herein, the side of the image forming apparatus 1 provided with a front door 10 will be referred to as a front surface (front face), and the surface on the opposite side of the front surface will be referred to as a rear surface (rear face). The right-hand side of the image forming apparatus 1 in a view from the side of the front surface will be referred to a driving side, and the left-hand side will be referred to as a non-driving side. The side on the top will be referred to as a top surface, and the side on the bottom will be referred to as a bottom surface. FIG. 2 is a sectional view of the image forming apparatus 1 in a view from the non-driving side. In FIG. 2, the side near to a viewer of this figure with respect to the picture plane of FIG. 2 corresponds to the non-driving side of the image forming apparatus 1; the right-hand side with respect to the picture plane corresponds to the front surface of the image forming apparatus 1, and the side far from the viewer of this figure with respect to the picture plane corresponds to the driving side of the image forming apparatus 1.

The driving side of the process cartridge 100 is a side provided with a drum coupling member (photosensitive body coupling member), which will be described later, in a view along an axial direction of the photosensitive drum 101, and is a side also provided with a developing coupling member, which will be described later, in a view along the axial direction of the developing roller (developing member) 103.

In the image forming apparatus main unit 2, first to fourth process cartridges 100 (100Y, 100M, 100C, 100K) are arranged substantially in a horizontal direction.

The first to the fourth process cartridges 100 (100Y, 100M, 100C, 100K) all have the same electrophotographic processing mechanism, with each cartridge filled with a different amount of a developer (hereinafter, referred to as toner) of a different color. Therefore, when it is not particularly necessary to distinguish one from the others, the subscripts Y to K will be omitted, and these process cartridges 100 will be explained at once.

The first to the fourth process cartridges 100 receive a rotating driving force transmitted from a drive output unit (to be described later in detail) included in the image forming apparatus main unit 2, and receives and supplied with bias voltages (such as a charging bias, a developing bias, a remaining electrostatic electricity detection bias) via a contact point (not illustrated) included in the image forming apparatus main unit 2.

As illustrated in FIG. 3, the process cartridge 100 according to this embodiment includes a drum unit 120 and a developing unit 150. The drum unit 120 includes a photosensitive drum 101 and a charging roller 102. The charging roller 102 is means for charging, which is means for processing, exerting an effect to the photosensitive drum 101. In addition to the means for charging, the drum unit 120 may also include means for cleaning, as means for processing. The developing unit 150 includes means for developing the electrostatic latent image on the photosensitive drum 101. The drum unit 120 and the developing unit 150 are coupled to each other. A more specific configuration of the process cartridge 100 will be described later.

The first process cartridge 100Y stores therein a yellow (Y) toner inside a developing frame body, and forms a yellow toner image on the surface of the photosensitive drum 101. The second process cartridge 100M stores therein a magenta (M) toner inside the developing frame body, and forms a magenta toner image on the surface of the photosensitive drum 101. The third process cartridge 100C stores therein a cyan (C) toner inside the developing frame body, and forms a cyan toner image on the surface of the photosensitive drum 101. The fourth process cartridge 100K stores therein a black (K) toner inside the developing frame body, and forms a black toner image on the surface of the photosensitive drum 101.

Above the first to the fourth process cartridges 100, a laser scanner unit 11 that is means for exposing is provided. This laser scanner unit 11 outputs a laser beam 12 (FIG. 3) in accordance with image information. The laser beam 12 is scanned across the surface of the photosensitive drum 101, so that the surface is exposed therewith, through an exposure window 128 provided to the process cartridge 100.

Below the first to the fourth process cartridges 100, an intermediate transfer unit 5 that is a transfer member is provided. This intermediate transfer unit 5 includes a driver roller 5e and a tension roller 5b, and a transfer belt 5a (intermediate transfer belt) that is flexible, and is stretched across these rollers.

The bottom surface of the photosensitive drum 101 in each of the first to the fourth process cartridges 100 is kept in contact with the top surface of the transfer belt 5a. This contact region forms a primary transfer unit. On the inner side of the transfer belt 5a, a primary transfer roller 5d corresponding thereto is provided, in a manner facing the photosensitive drum 101.

The driver roller 5e is kept in contact with the secondary transfer roller 6, with the transfer belt 5a interposed therebetween. This contact region between the transfer belt 5a and the secondary transfer roller 6 forms a secondary transfer unit.

Below the intermediate transfer unit 5, a feeding unit 4 is provided. The feeding unit 4 includes a paper feeding tray 4a where a stack of recording media 3 is stored, and a paper feeding roller 4b.

On the upper right-hand side of the image forming apparatus main unit 2 in FIG. 2, a fixing apparatus 7 and a paper ejecting apparatus 8 are provided, and the top surface of the image forming apparatus main unit 2 provides a paper ejecting tray 9. A recording medium 3 having a toner image fixed with means for fixing, provided to the fixing apparatus 7, is ejected onto the paper ejecting tray 9.

The image forming apparatus 1 includes a control unit 250. The control unit 250 is implemented as an information processing apparatus or a processing circuit having computational resources such as a processor and a memory. During image forming operations of the image forming apparatus 1, the components of the image forming apparatus 1 are caused to operate, on the basis of image information provided by an external apparatus or image information read by a scanner, to form an image on the recording medium 3. Such an image forming operation is performed by causing the control unit 250 to control each of the components of the image forming apparatus 1, in accordance with a computer program loaded onto the memory, or on the basis of an instruction entered by a user.

### Image Forming Operation

An operation for forming a full-color image is performed in the manner described below. Each step of the image forming operation is performed by causing the control unit 250 to communicate with a component corresponding thereto and to control the component.

The photosensitive drums 101 included in the first to the fourth process cartridges 100, respectively, are driven in rotation at a predetermined speed (in the direction of the arrow A in FIG. 3). The transfer belt 5a is also driven in rotation in a direction following the direction of the rotation of the photosensitive drum 101 (in the direction of the arrow B in FIG. 2), at a speed corresponding to the speed of the photosensitive drums 101.

The laser scanner unit 11 is driven on the basis of image information, and scans across the surface of each of the photosensitive drums 101 and exposes the surface with a laser beam 12, on the basis of an image signal of the corresponding color. Synchronously with driving of the laser scanner unit 11, the charging rollers 102 included in the respective process cartridges 100 charge the surfaces of the respective photosensitive drums 101 uniformly to a predetermined potential with a predetermined polarity. In this manner, an electrostatic latent image corresponding to the image signal of the corresponding color is formed on the surface of the photosensitive drum 101.

The developing roller 103 is driven in rotation in the direction following the direction of the rotation of the photosensitive drum 101 (in the direction of the arrow C in FIG. 3) at a predetermined speed. The developer supplying roller 104 supplies the developer onto the developing roller 103 by rotating in the direction of the arrow D in FIG. 3. The developer in the developing roller 103 is thus supplied onto the photosensitive drum 101, and the electrostatic latent image formed on the surface of the photosensitive drum is developed therewith.

Through the operation of the electrophotographic image forming process described above, a yellow toner image corresponding to a yellow component of the full-color image is formed on the photosensitive drum 101, in the first process cartridge 100Y. The toner image is then primarily transferred onto the transfer belt 5a.

In the same manner, a magenta toner image corresponding to a magenta component of the full-color image is formed on the photosensitive drum 101, in the second process cartridge 100M. The toner image is then primarily transferred in a manner superimposed over the yellow toner image having been already transferred onto the transfer belt 5a.

In the same manner, a cyan toner image corresponding to a cyan component of the full-color image is formed on the photosensitive drum 101, in the third process cartridge 100C. The toner image is then primarily transferred in a manner superimposed over the yellow and the magenta toner images having been already transferred onto the transfer belt 5a.

In the same manner, a black toner image corresponding to a black component of the full-color image is formed on the photosensitive drum 101, in the fourth process cartridge 100K. The toner image is then primarily transferred in a manner superimposed over the yellow toner image, the magenta toner image, and the cyan toner image having been already transferred onto the transfer belt 5a.

In the manner described above, a full-color unfixed toner image including the four colors of yellow, magenta, cyan, and black is formed on the transfer belt 5a.

Meanwhile, at a predetermined control timing, the paper feeding roller 4b is caused to separate a recording medium 3 in the paper feeding tray 4a, and to feed the separated recording medium 3, one sheet at a time. The recording medium 3 is then guided into the secondary transfer unit that is a contact region between the secondary transfer roller 6 and the transfer belt 5a, at a predetermined control timing. With this, through the process of conveying the recording medium 3 into the secondary transfer unit, the four-color toner images on the transfer belt 5a are transferred at once onto the recording medium 3, sequentially.

The configuration of the image forming apparatus main unit 2 will now be explained more in detail.

### General Description of Configuration for Mounting and Removing Process Cartridge

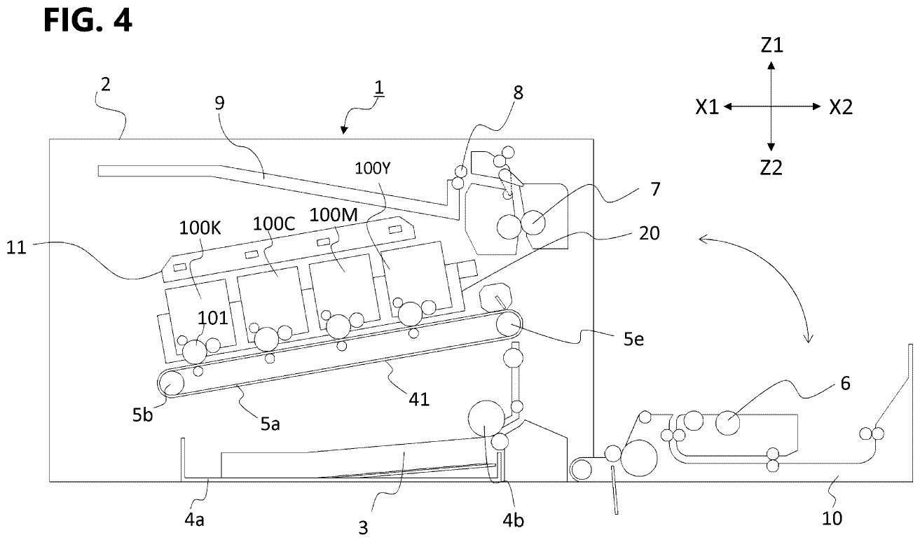

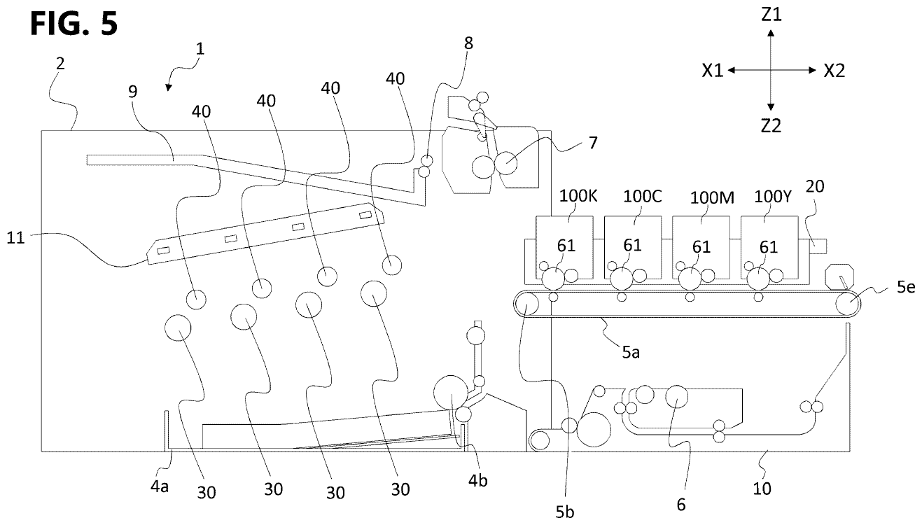

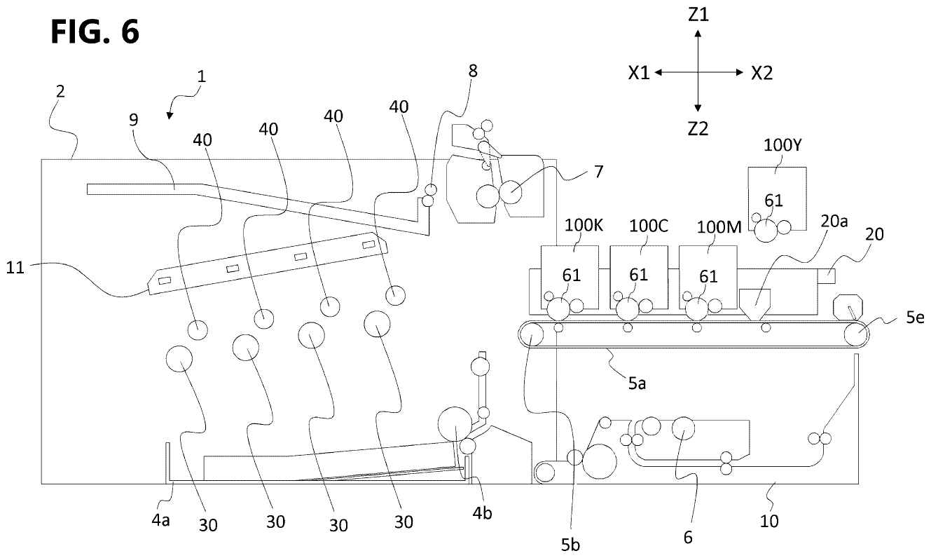

A cartridge tray for supporting the process cartridge 100 (hereinafter, referred to as a tray 20) will now be explained more in detail with reference to FIGS. 4 to 6. FIG. 4 is a sectional view of the image forming apparatus 1 with the tray 20 disposed inside the image forming apparatus main unit 2, but with the front door 10 opened. FIG. 5 is a sectional view of the image forming apparatus 1 with the tray 20 disposed outside of the image forming apparatus main unit 2, with the front door 10 opened, but with the process cartridges 100 still housed inside the tray 20. FIG. 6 is a sectional view of the image forming apparatus 1 with the tray 20 disposed outside of the image forming apparatus main unit 2, with the front door 10 opened, and with the process cartridge 100 (100Y) being removed from the tray 20.

As illustrated in FIGS. 4 and 5, the tray 20 is movable in the directions of the arrow X1 (pushing direction) and the arrow X2 (pulling direction), with respect to the image forming apparatus main unit 2. The direction of the arrow X1 and the direction of the arrow X2 may be substantially horizontal or inclined with respect to the horizontal direction. In other words, the tray 20 is provided in a manner enabled to be pulled out of and pushed into the image forming apparatus main unit 2, and the tray 20 is movable in a substantially horizontal direction, with the image forming apparatus main unit 2 installed on a horizontal surface. This position of the tray 20 on the inner side of the image forming apparatus main unit 2 with the front door 10 opened (the position illustrated in FIG. 4) will be referred to as an inner position. This position of the tray 20 outside of the image forming apparatus main unit 2 (the position illustrated in FIG. 5) will be referred to as an outer position. At the inner position and the outer position, the photosensitive drums 101 and the transfer belt 5a are separated from each other.

The tray 20 also has, as illustrated in FIG. 6, an attachment 20a allowing the first process cartridge 100Y to be mounted, in a manner allowing the first process cartridge 100Y to be removed when the tray 20 is at the outer position. The tray 20 also includes attachments 20a enabling the second to the fourth process cartridges 100M, 100C, 100K to be mounted removably, respectively. As the tray 20 is moved, the process cartridges 100 on the respective attachments 20a move into the image forming apparatus main unit 2. In this embodiment, by closing the front door 10, a link mechanism, not illustrated, is caused to move the intermediate transfer unit 5 upwards in the direction of the arrow Z1, to the position for forming an image (the position where the photosensitive drum 101 and the transfer belt 5a come into contact with each other). By opening the front door 10, the intermediate transfer unit 5 is caused to move downwards in the direction of the arrow Z2, and the photosensitive drum 101 and the transfer belt 5a separate from each other.

As described above, by using the tray 20, it is possible to move a plurality of the process cartridges 100 all at once, to a position where images can be formed, inside the image forming apparatus main unit 2, and to be pulled outside of the image forming apparatus main unit 2 all at once.

### Overall Configuration of Process Cartridge

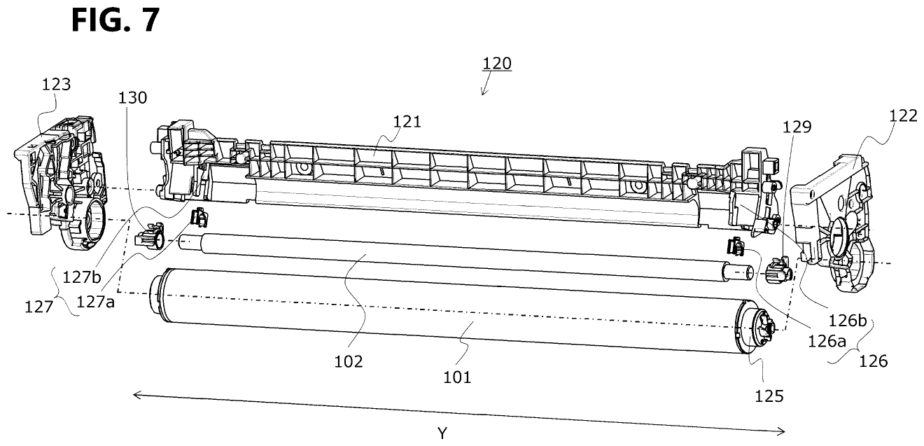

A configuration of the process cartridge will now be explained with reference to FIGS. 7 to 10.

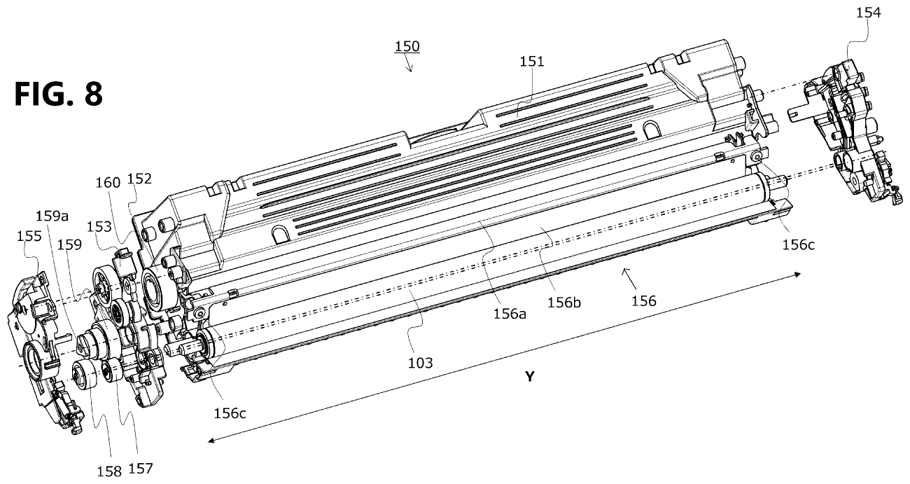

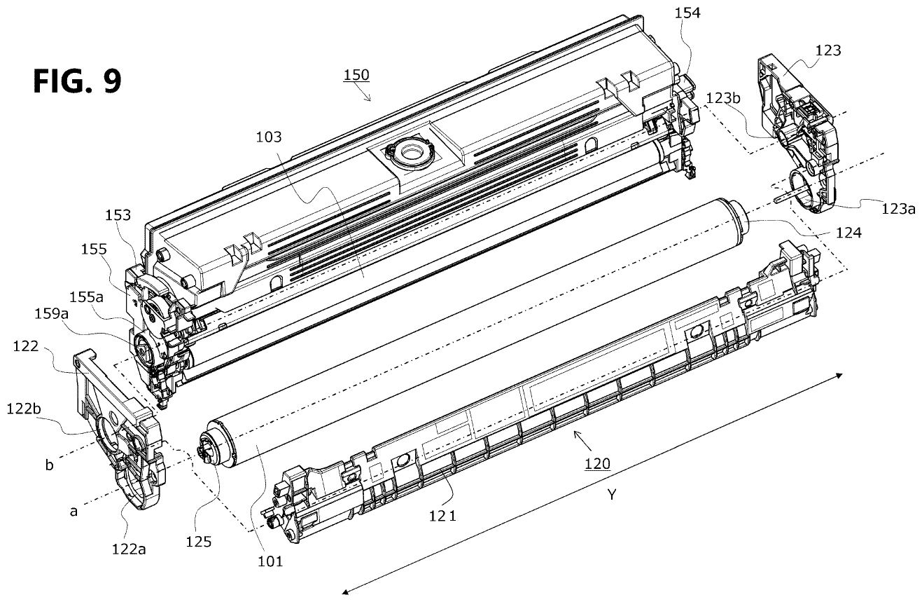

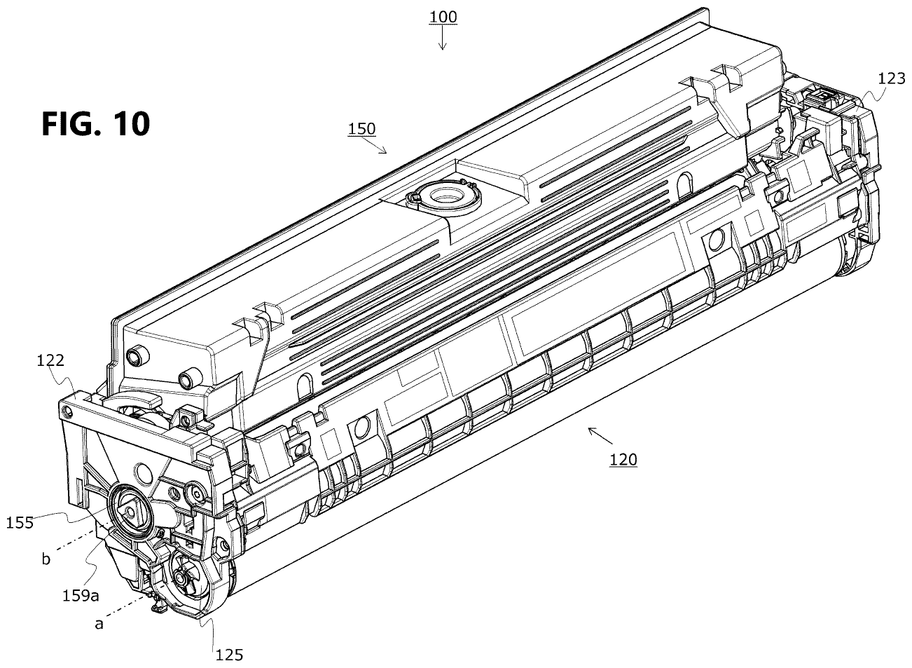

FIG. 7 is an exploded perspective view of the drum unit 120. FIG. 8 is an exploded perspective view of the developing unit 150. FIG. 9 is an assembly perspective view of the process cartridge 100, in a view from the driving side that is a one-end side of the photosensitive drum 101 in the axial direction. FIG. 10 is a perspective view of the process cartridge 100 in a view from the driving side.

The process cartridge 100 is provided with the photosensitive drum 101, and processing means exerting effects to the photosensitive drum 101. Examples of the processing means herein include the charging roller 102 that is the charging means for charging the photosensitive drum 101, and the developing roller 103 that is the developing means for developing a latent image formed on the photosensitive drum 101. The process cartridge 100 is divided into the drum unit 120 and the developing unit 150, as mentioned earlier.

In the description below, the longitudinal direction Y of the drum unit 120 and the developing unit 150 is a direction substantially in parallel with the rotation axis a of the photosensitive drum 101 (FIG. 9).

### Configuration of Drum Unit

As illustrated in FIGS. 7 and 9, the drum unit 120 includes the photosensitive drum 101, the charging roller 102, a drum frame body 121. The charging roller 102 is rotatably supported by a driving-side charging roller bearing 126a and a non-driving-side charging roller bearing 127a, and is biased against the photosensitive drum 101 (in the direction of the arrow F in FIG. 3) by pressing springs 126b, 127b. The photosensitive drum 101 is rotatably supported by a driving-side cartridge cover member 122 and a non-driving-side cartridge cover member 123 that are provided to the respective ends of the process cartridge 100 in the longitudinal direction.

As illustrated in FIG. 9, one end of the photosensitive drum 101 in the longitudinal direction is provided with a coupling member 125 via which a driving force is communicated to the photosensitive drum 101. The coupling member 125 is engaged with a main body side drum driving coupling 30 (FIG. 5) serving as a drum drive output unit in the image forming apparatus main unit 2, so that the driving force of a driving motor 252 included in the image forming apparatus main unit 2 is transmitted to cause the photosensitive drum 101 to rotate in the direction of the arrow A in FIG. 3. The photosensitive drum 101 also has a drum flange 124 on the side of the other end in the longitudinal direction. The driving-side charging roller bearing 126a and the non-driving-side charging roller bearing 127a supporting the charging roller 102 are supported on the drum frame body 121 in a manner enabling the charging roller 102 to come into contact with and be driven by the photosensitive drum 101 (in the direction of the arrow E in FIG. 3).

### Configuration of Developing Unit

The developing unit 150 includes, as illustrated in FIGS. 3 and 8, the developing roller 103, the developer supplying roller 104, a developing blade 156, and the developing frame body. The developing frame body includes a first developing frame body 151 and a second developing frame body 152. The first developing frame body 151 and the second developing frame body 152 are bonded by ultrasonic bonding, for example. The developing frame body includes the toner housing 162 for storing the toner to be supplied to the developing roller 103. The developing frame body also supports the developing roller 103 and the developer supplying roller 104 via a driving-side bearing 153 and a non-driving-side bearing 154, and holds the developing blade 156 for restricting the thickness of the toner layer on the circumferential surface of the developing roller 103.

The developing blade 156 is an elastic member 156b that is a sheet metal having a thickness of 0.1 mm or so, attached to a support member 156a that is made of a metal material having L-shaped cross section. The developing blade 156 is attached to the developing frame body with fixing screws 156c at two points that are on one end and the other end of the developing blade 156 in the longitudinal direction.

One end of the developing unit 150 in the longitudinal direction is provided with a developing driving input gear 159 for transmitting the driving force to the developing unit 150. The developing driving input gear 159 is provided with a developing input coupling portion 159a receiving a driving force from a main-body-side developing driving coupling 40 of the image forming apparatus main unit 2 (FIG. 4), and the driving force of the driving motor (not illustrated) in the image forming apparatus main unit 2 is input to the developing unit 150.

The driving force input to the developing unit 150 is transmitted to a developing roller gear 157 to cause the developing roller 103 to rotate in the direction of the arrow C in FIG. 3, and also is transmitted to a developer supplying roller gear 158 to cause the developer supplying roller 104 to rotate in the direction of the arrow D in FIG. 3. The driving force is also transmitted to a stirring gear 160 to cause a stirring member 161 to rotate in the direction of the arrow H in FIG. 3, so that the toner in the toner housing 162 is stirred thereby.

The stirring member 161 has a rotation shaft 161a extending in parallel with the direction of the rotational axis of the developing roller 103, and a stirring sheet 161b that is a flexible sheet. Because the stirring sheet 161b not only stirs the developer but also conveys the developer, the stirring sheet 161b can also be referred to a conveying member. The one-end side of the stirring sheet 161b is attached to the rotation shaft 161a. The other-end side of the stirring sheet 161b is a free end, so that the toner is stirred by the stirring sheet 161b being caused to rotate as the rotation shaft 161a is rotated. “The other-end side” herein is a part at least including an upstream bonded portion 169 and a downstream bonded portion 170, which are to be described later. Because the stirring member 161 not only stirs the toner but also conveys the toner to the developing chamber 166, the stirring member 161 will be also referred to as a conveying member.

The one-end side of the developing unit 150 in the longitudinal direction is provided with a developing cover member 155 that supports and covers the developing driving input gear 159.

### Assembling of Drum Unit and Developing Unit

Assembling of the drum unit 120 and the developing unit 150 will now be explained with reference to FIG. 9. Using the driving-side cartridge cover member 122 and the non-driving-side cartridge cover member 123 that are provided to the respective ends of the process cartridge 100 in the longitudinal direction, the drum unit 120 and the developing unit 150 are coupled with each other. The driving-side cartridge cover member 122, which is provided to the one-end side of the process cartridge 100 in the longitudinal direction, has a developing unit supporting hole 122b for swingably (movably) supporting the developing unit 150. Similarly, the non-driving-side cartridge cover member 123, which is provided to the other-end side of the process cartridge 100 in the longitudinal direction, has a developing unit supporting hole 123b for swingably supporting the developing unit 150.

The driving-side cartridge cover member 122 and the non-driving-side cartridge cover member 123 also have a drum supporting hole 122a and a drum supporting hole 123a, respectively, for rotatably supporting the photosensitive drum 101. On the one-end side, the external circumference of a cylindrical portion 155a that is provided to the developing cover member 155 is engaged with the developing unit supporting hole 122b provided to the driving-side cartridge cover member 122. On the other-end side, the external circumference of a cylindrical portion (not illustrated) that is provided to the non-driving-side bearing 154 is engaged with the developing unit supporting hole 123b provided to the non-driving-side cartridge cover member 123.

The respective ends of the photosensitive drum 101 in the longitudinal direction are also engaged with the drum supporting hole 122a of the driving-side cartridge cover member 122 and with the drum supporting hole 123a of the non-driving-side cartridge cover member 123, respectively. The driving-side cartridge cover member 122 and the non-driving-side cartridge cover member 123 are then fixed to the drum unit 120 using screws or adhesive, not illustrated. In this manner, the driving-side cartridge cover member 122 and the non-driving-side cartridge cover member 123 come to rotatably support the developing unit 150 with respect to the drum unit 120 (the photosensitive drum 101), and the developing roller 103 is enabled be brought to a position for exerting an effect to the photosensitive drum 101 during the image formation.

FIG. 10 illustrates the process cartridge 100 that is the drum unit 120 and the developing unit 150 assembled as one unit, through the process described above. During time such as the time of non-image formation, by keeping separator members 129, 130 in contact with a contacted region of the developing unit 150, the photosensitive drum 101 of the drum unit 120 can be kept away from the developing roller 103 of the developing unit 150.

An axial line that connects the center of the developing unit supporting hole 122b of the driving-side cartridge cover member 122 and the center of the developing unit supporting hole 123b of the non-driving-side cartridge cover member 123 will be referred to as a swinging axis b. At this time, the cylindrical portion 155a, which is on the one-end side of the developing cover member 155, and the developing input coupling portion 159a are on the same axis. In other words, the developing unit 150 is configured to receive the driving force from the image forming apparatus main unit 2 along the swinging axis b. About the swinging axis b, the developing unit 150 is pivotably supported, too.

### Configuration for Opening Sealing Member

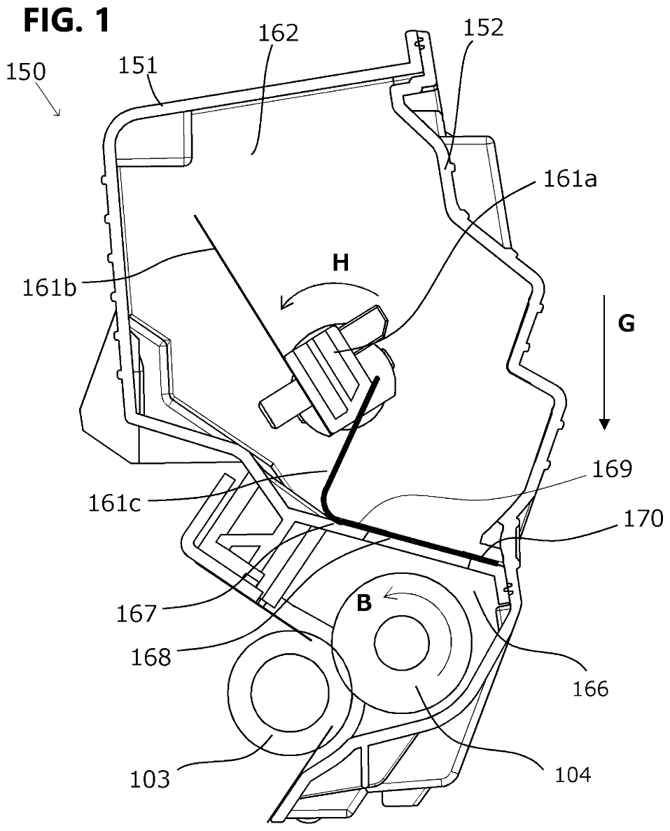

As illustrated in FIG. 1, the developing unit 150 is divided into the developing chamber 166 that includes the developing roller 103 and the developer supplying roller 104, and the toner housing 162 that stores therein the toner, and has an opening 168 for communicably connecting the developing chamber 166 and the toner housing 162.

The opening 168 is kept sealed with a sealing member 161c so that the developer is sealed inside the toner housing 162 until the cartridge is put into use by a user, from when the cartridge is manufactured. The sealing member 161c is bonded to a separator wall 167, with an upstream bonded portion 169 provided to the upstream in the rotating direction of the stirring member 161, and the downstream bonded portion 170 provided downstream in the rotating direction. As the way in which the sealing member 161c is fixed to the opening 168, a heat sealing such as thermal bonding used, but it is also possible to use a fixing method such as ultrasonic bonding or double sided tape.

When a user puts the cartridge in use, the stirring member 161 inside the toner housing 162 rotates in a direction H, and causes the sealing member 161c to peel off from the opening 168. The stirring sheet 161b then conveys the developer toward the developing chamber 166. At that time, the stirring sheet 161b conveys the developer while rubbing the inner wall of the toner housing 162 or the developer by deforming elastically.

In this disclosure, the stirring member 161 and the developer supplying roller 104 are designed to rotate in the respective rotating directions (H, B). The rotational axis of the stirring member 161 is disposed at a position equal to or higher than the height of the rotational axis of the developer supplying roller 104, in the gravitational direction G. With this configuration, it is possible to supply a sufficient amount of developer into a void 166a formed inside the developing chamber 166, as will be explained later. As a result, it is possible to provide a cartridge having an improved image quality, requiring a shorter time in an initial installation sequence, and having better usability. One of the reasons why the initial installation sequence is required is that the developing roller 103 needs to be applied with a sufficient amount of coating of developer after the sealing member is peeled off and the developing chamber 166 opens, in order to achieve a high-quality image. Therefore, to reduce the time of the initial installation sequence, it is effective to improve the performance at which the developer is supplied into the developing chamber 166.

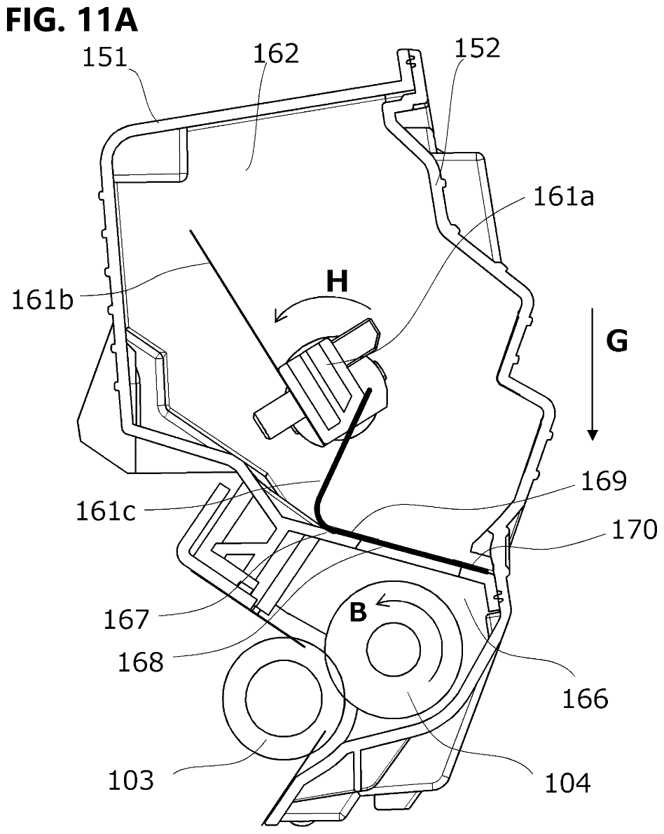

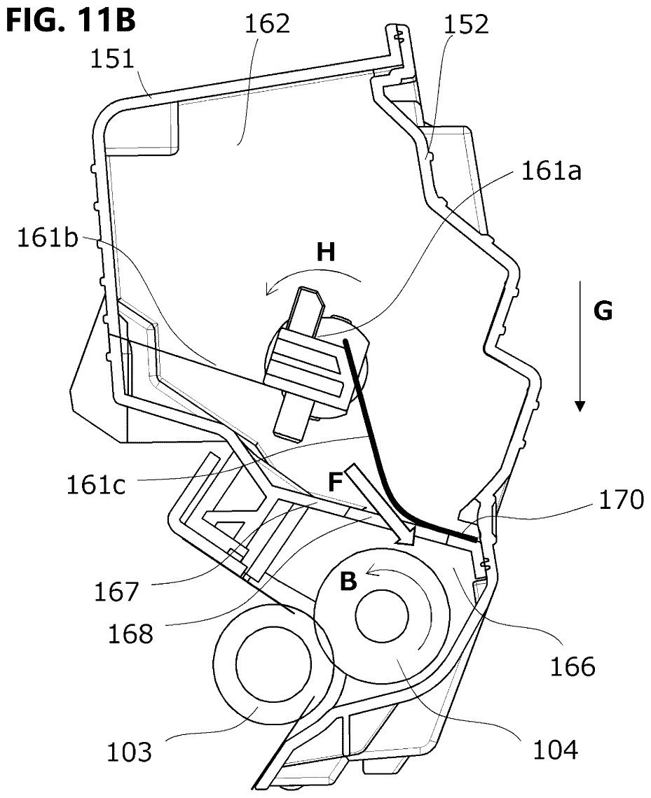

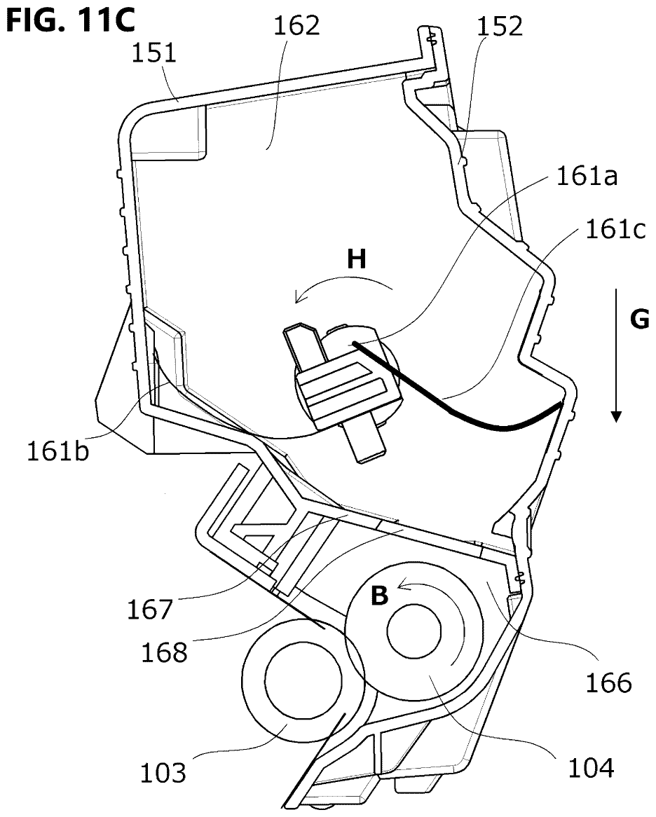

The configuration for opening the sealing member will now be explained with reference to FIG. 1 and FIGS. 11A to 11C. Until the user puts the cartridge in use, the sealing member 161c keeps the opening 168 sealed, as illustrated in FIGS. 1 and 11A, so that the developer is not supplied into the developing chamber 166. When an image is to be formed for the first time after the factory shipment, the stirring member 161 is caused to rotate by the initial installation sequence for peeling off the sealing member 161c. As the stirring member 161 is rotated in the H direction, the upstream bonded portion 169 peels off, to begin with (FIG. 11B).

Because the developer becomes movable in the direction of the arrow F, immediately after the upstream bonded portion 169 peels off, the performance at which the toner is supplied into the developing chamber 166 is improved, compared with the configuration in which the downstream bonded portion 170 peels off at first. Hence, it is possible to reduce the time required in the initial installation sequence. Furthermore, by allowing the toner to be supplied into the developing chamber 166 immediately after the upstream bonded portion 169 peels off, it is possible to suppress an increase in a torque resultant of toner aggregation inside of the toner housing 162. As the stirring member 161 rotates further, the downstream bonded portion 170 peels off, as illustrated in FIG. 11C, and the opening 168 becomes completely open.

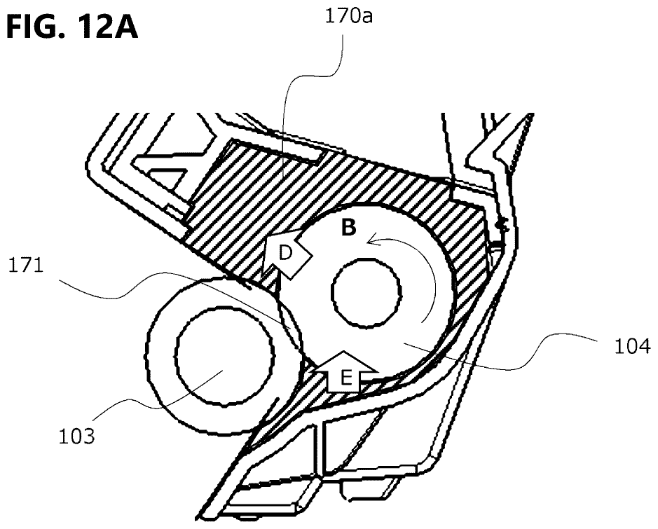

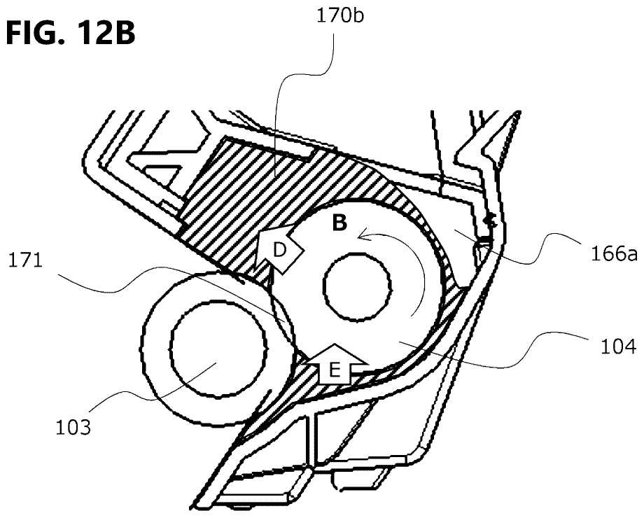

FIGS. 12A and 12B are schematics illustrating a problem to be solved by the embodiment. A general phenomenon experienced by the developer supplying roller 104 will now be explained with reference to FIG. 12A. FIG. 12A is a sectional view near the developer supplying roller 104, with the internal space of the developing chamber 166 filled with filled developer 170a. The developer supplying roller 104 has an elastic urethane sleeve, and the developer is held inside this urethane sleeve. The developing roller 103 and the developer supplying roller 104 are held in contact longitudinally, inside the developing chamber 166, with the elastic part of the developer supplying roller 104 disposed in a manner partially compressed by the developing roller 103 that is harder.

FIG. 12A illustrates a developer supplying roller compressed region 171. On the upstream side of the developer supplying roller compressed region 171 in the rotating direction B of the developer supplying roller 104, because the elastic part having been uncompressed becomes compressed, the elastic part releases the developer in the direction of the arrow D. By contrast, on the downstream side of the compressed region 171 of the elastic part of the supplying roller, the developer is sucked into the elastic part in the direction of the arrow E, because the elastic part having been compressed recovers to the original shape.

The condition inside the developing chamber 166 resultant of the phenomenon, and a problem caused by the phenomenon will now be explained with reference to FIG. 12B. Because, on the downstream side of the compressed region 171 in the rotating direction B of the developer supplying roller 104, the amount of developer decreases as a result of the developer being sucked (in the direction of the arrow E), the developer comes to have a distribution as indicated as filled developer 170b, with a void 166a formed. The volume of the void 166a changes depending on the amount of developer consumed or the condition of the supplying roller 104, which are dependent on the images having been formed and are not predictable. When there is a void 166a, the sponge on the developer supplying roller 104 may fail to hold a sufficient amount of developer and cause an image defect due to a failure in the developer supply, particularly when the amount of remaining toner in the cartridge is low.

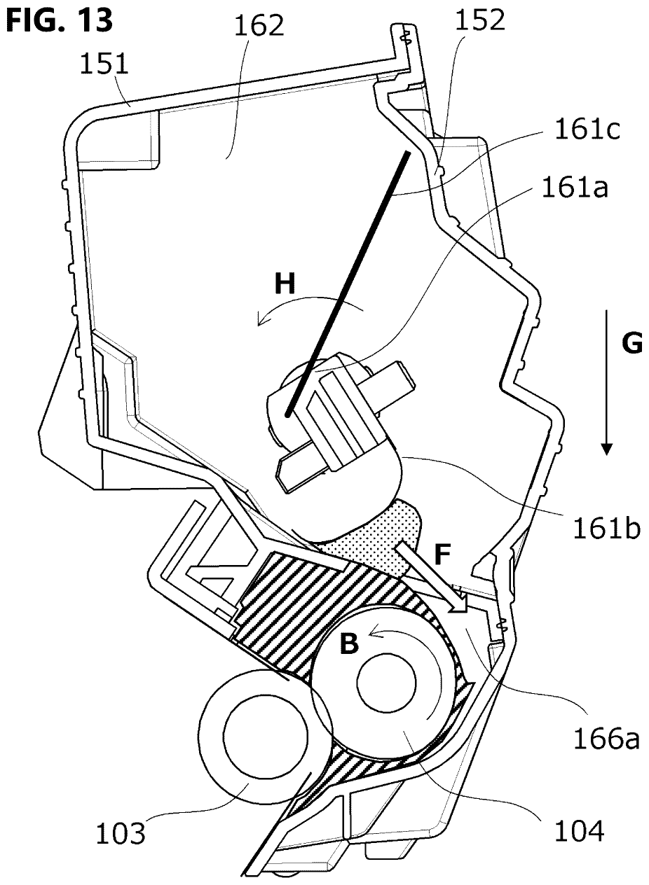

A solution to this problem in this embodiment will now be explained with reference to FIG. 13. In order to achieve a better developer supplying effect into the void 166a, it is necessary to keep the void 166a downstream of the opening 168 in the conveying direction H, and to convey and to fill the developer along the direction of the arrow F in FIG. 13. According to this present disclosure, because the stirring member 161 rotates in the direction H, a sufficient amount of the developer can be supplied into the void 166a.

As described above, with the configuration according to the present disclosure, it is possible to supply the developer into the void having been formed near the developer supplying roller 104. Therefore, it is possible to supply a sufficient amount of developer to the developing roller 103 throughout the entire lifetime of the cartridge, and to improve the image quality. Furthermore, because the developer can be supplied to the developing chamber 166 immediately after the sealing member peels off, it is possible to reduce the time of the initial installation sequence, which is accrued when the cartridge is put into use for the first time, and to improve the usability.

In the configuration according to the present disclosure, bonded portions are provided to both of the upstream and downstream sides of the opening 168 in the rotating direction of the stirring member 161, and the toner seal is bonded at such positions that the seal is removed from the upstream bonded portion 169 and the downstream bonded portion 170, in the order listed herein. At this time, the rotating direction of the developer supplying roller 104 is matched with the rotating direction of the stirring member 161. Furthermore, the rotation shaft of the stirring member 161 is provided at a position equal to or higher than the height of the rotation shaft of the developer supplying roller 104, in the gravitational direction. With this configuration, it is possible to better supply the developer to the developer supplying roller 104, to reduce the time of the initial installation sequence, and to improve the image quality when the amount of the remaining toner is low.

The configuration according to the present disclosure is applicable to a developer container where the developer is stored, to a developing apparatus that uses developer to develop an electrostatic latent image on a photosensitive drum, or to an image forming apparatus provided with such a developing apparatus. Furthermore, the configuration according to the present disclosure is also applicable to a developing cartridge or a process cartridge including such a developer container, and that is removable from the main body of an image forming apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-057905, filed on Mar. 29, 2024, which is hereby incorporated by reference wherein in its entirety.

What is claimed is:

1. A developer container comprising:
a developing roller configured to supply developer to a photosensitive drum;
a supplying roller configured to be rotatable and to supply the developer to the developing roller;
a developing chamber provided with the developing roller and the supplying roller;
a developer housing configured to store the developer and having an opening that communicably connects the developer housing and the developing chamber; and
a stirring member provided inside the developer housing and configured to stir the developer, and moreover configured to be rotatable in a same direction as a direction in which the supplying roller rotates, wherein
a height of a rotation shaft of the stirring member is equal to or higher than a height of a rotation shaft of the supplying roller, in a gravitational direction,
the developer housing is enabled to be provided with a sealing member for sealing the opening, from a side of the developer housing,
in a state where the opening is sealed by the sealing member, the sealing member is bonded at an upstream bonded portion that is on an upstream side of the opening and also at a downstream bonded portion that is on a downstream side of the opening, in a rotating direction of the stirring member, and
the developer housing and the developing chamber come to communicate each other as a result of the sealing member peeling off, starting from the upstream bonded portion and then the downstream bonded portion.

2. The developer container according to claim 1, wherein
a one-end side of the sealing member is attached to a rotation shaft of the stirring member,
an another-end side of the sealing member is bonded at the upstream bonded portion and at the downstream bonded portion in a state where the opening is kept sealed with the sealing member,
the upstream bonded portion of the sealing member is positioned nearer to the one-end side than the downstream bonded portion, and
the sealing member is configured to peel off starting from the upstream bonded portion, and then the downstream bonded portion in conjunction with rotation of the stirring member.

3. A developer container comprising:
a developing roller configured to supply developer to a photosensitive drum;
a supplying roller configured to be rotatable and to supply the developer to the developing roller;
a developing chamber provided with the developing roller and the supplying roller;
a developer housing configured to store the developer and having an opening that communicably connects the developer housing and the developing chamber;
a stirring member provided inside the developer housing and configured to stir the developer, and moreover configured to be rotatable in a same direction as a direction in which the supplying roller is rotated, wherein
a height of a rotation shaft of the stirring member is equal to or higher than a height of a rotation shaft of the supplying roller, in a gravitational direction,
the developer housing is enabled to be provided with a sealing member for sealing the opening, from a side of the developer housing,
in a state where the opening is sealed by the sealing member, the sealing member is bonded at an upstream bonded portion that is on an upstream side of the opening and also at a downstream bonded portion that is on a downstream side of the opening, in a rotating direction of the stirring member, and
the sealing member includes a part that is attached to a rotation shaft of the stirring member, a part that is bonded at the upstream bonded portion, and a part bonded at the downstream bonded portion, in this order, along a direction from a one-end side toward an another-end side.
